(19) United States
(12) Patent Application Publication
(10) Pub. No.: US 2015/0314496 A1
(43) Pub. Date: Nov. 5, 2015

(54) INJECTION MOLDS AND METHOD OF INJECTION MOLDING

(71) Applicant: Cascade Engineering, Inc., Grand Rapids, MI (US)

(72) Inventors: Michael T. Campbell, Grand Rapids, MI (US); Timothy E. VanAst, Grand Rapids, MI (US)

(73) Assignee: Cascade Engineering, Inc., Grand Rapids, MI (US)

(21) Appl. No.: 14/267,962

(22) Filed: May 2, 2014

(51) Int. Cl. B29C 45/00

(52) U.S. Cl. CPC B29C 45/0046; B29L 2031/7324

(57) ABSTRACT

The specification discloses a patterned thickness article, a patterned injection molding, and a method for manufacturing the article. The injection molding has patterned internal surface including high-flow channels and a plurality of intermediate and/or lower-flow channels having varying cross-sectional areas within the injection molding. The method includes providing such an injection molding; providing a flow of molten material through a sprue and into the high-flow channels; creating a flow front in the injection molding that advances from the sprue along the high-flow channels and the intermediate and/or lower-flow channels; and applying a clamping pressure to said injection molding.

### BACKGROUND OF THE INVENTION

The present invention relates to injection moldings and methods for injection molding.

Injection molding an article typically involves the injecting of molten material into a molding cavity, allowing the material to cool, cure, set, or freeze, and then removing the article from the molding. Commonly, melted polymers are injected into metal moldings to fabricate the article.

Frequently, the moldings are shaped to form features of the article. Some of these features require narrow spaces between the surfaces of an injection molding. Unfortunately, during filling of the molding with the melted material, the material may freeze or cure before completely filling the narrow spaces between the surfaces of the molding. These issues are particularly troublesome when designing injection molded articles having multiple narrow or thin areas, or a large area of thin spacing.

Solutions to these types of issues have included increasing the number of sprue orifices through which the melted material enters the molding. However, the use of multiple sprue orifices often results in gas being trapped between the material injected from neighboring sprues creating unwanted air or gas bubbles in the finished article. Further, if there is constant flow pressure, the material will move slower as the number of drops increases further hindering a complete fill of the molding before the material freezes.

Another solution to the problem of filling narrow portions of a molding cavity has included increasing both the injection pressure and the clamping pressure on the molding. However, it sometimes is not practical or possible to sufficiently increase the pressures to achieve a complete fill of narrow molding spaces.

### SUMMARY OF THE INVENTION

The present invention provides an injection molding with a pattern of thick and thin cross-sectional areas to allow for easier filling while maintaining an overall lower average thickness, thus reducing the injection pressure and the clamp pressure required for the molding and reducing the amount of material required to make an article.

As disclosed, the injection molding has a high-flow channel in communication with a sprue orifice. The high-flow channel having a cross-sectional area within the injection molding. A lower-flow channel is adjacent to the high-flow channel and has a smaller cross-sectional area within said injection molding as compared to the cross-sectional area of the high-flow channel.

The present invention also includes a method of molding using the molding. The method includes the step of providing a flow of molten material through the sprue orifice and into the high-flow channel, and creating a flow front of said molten material within the injection molding. The flow front advances along the high-flow channel and into the lower-flow channel. A clamping pressure is applied to the molding.

The present invention further includes a molded article manufactured using the molding and the method. The article as disclosed is fabricated of thermoplastics, thermosetting resins and elastomers.

The features and advantages of the present invention will be more fully understood by reference to the description of the current embodiment and the drawings.

### BRIEF DESCRIPTION OF THE DRAWINGS

FIG. 1 is a graph of plastic flow.

FIG. 2 is schematic diagram of a molding with multiple hot drops.

FIG. 3 is top view of a mat molded with a consistent nominal thickness.

FIG. 4 is a perspective view of a variable thickness mat.

FIG. 5 is a schematic end view of a variable thickness mat.

FIG. 6A is perspective view of an injection molding with flow patterns indicated.

FIG. 6B is a partial perspective view of a variable thickness mat.

FIG. 7 is a perspective view of a variable thickness mat.

FIG. 8 is a schematic diagram of a patterned molding.

FIG. 9A is schematic of half a molding with a nominal thickness.

FIG. 9B is a schematic of half a molding with a nominal thickness.

FIG. 9C is a schematic of half a molding with one-quarter of the molding having a variable thickness.

FIG. 9D is a schematic of half an injection molding with variable thickness.

FIG. 10 is a bar graph comparing clamp tonnage required for moldings of constant nominal thickness and variable thickness.

FIG. 11A is a representation of a fill pattern for a molding with a consistent nominal thickness.

FIG. 11B is a representation of a fill pattern for a molding with a consistent nominal thickness.

FIG. 12A is a representation of a fill pattern for a molding with a consistent nominal thickness.

FIG. 12B is a representation of a fill pattern for a molding with a consistent nominal thickness.

FIG. 13A is a representation of a fill pattern for a molding with a variable thickness.

FIG. 13B is a representation of a fill pattern for a molding with a variable thickness.

FIG. 14A is a representation of a fill pattern for a molding with a variable thickness.

FIG. 14B is a representation of a fill pattern for a molding with a variable thickness.

### DESCRIPTION OF THE CURRENT EMBODIMENT

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof are meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

The mat, method and patterned injection molding provide a reduced volume, low cost article. The injection molded mat is generally flat with a profile of varying thickness with a low overall average thickness. The injection molding includes a patterned internal thickness across the generally flat molding that includes flow paths of flow channels that can facilitate the rapid filling of the molding. The narrower areas within the molding are filled before the flow front races past these areas avoiding gas traps. The method provides a substantially evenly filled article of minimized volume.

Directional terms, such as “vertical,” “horizontal,” “top,” “bottom,” “upper,” “lower,” “inner,” “inwardly,” “outer” and “outwardly,” are used to assist in describing the invention based on the orientation of the embodiments shown in the illustrations. The use of directional terms should not be interpreted to limit the invention to any specific orientation(s).

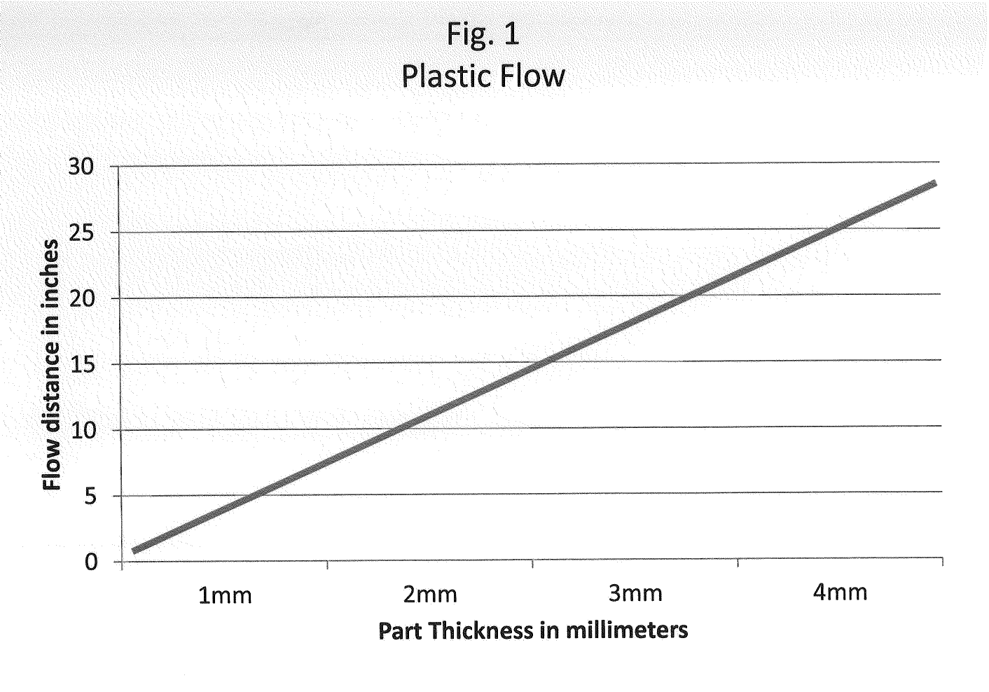

Melted plastic introduced into a molding to form an article will set or “freeze” when the plastic approaches its setting temperature. The distance the melted plastic can travel in the molding before it freezes depends, at least in part, upon the internal thickness of molding. Typically, the relationship between flow distance of melted plastic before freezing and interior thickness of the molding is linear, such as the example shown in FIG. 1. However, some relationships may be non-linear.

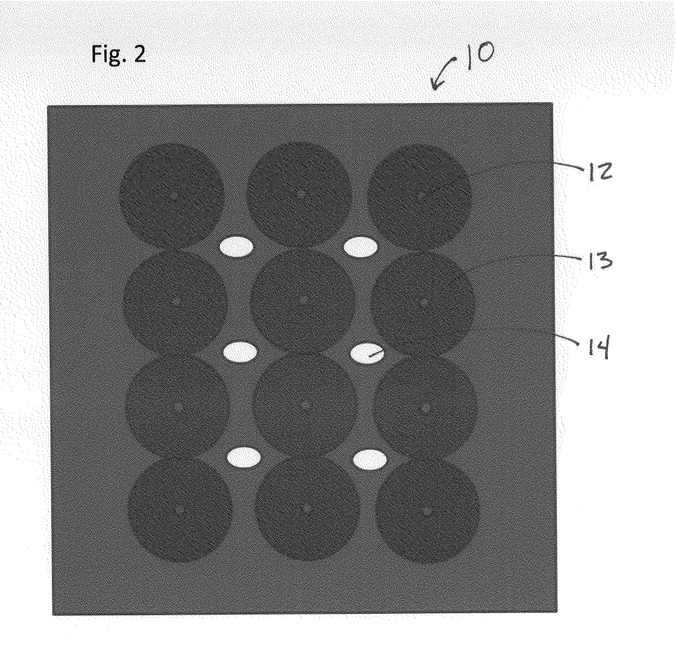

In filling moldings with thinner interior thicknesses, it may be helpful to introduce the melted plastic into a plurality of openings in the molding. For example, as shown in FIG. 2, a molding 10 may include multiple sprue orifices 12 to introduce several allocations of melted plastic, or hot drop, 13 into the molding 10. However, gas traps 14 may form between the hot drops 13 resulting in an article that is not completely formed. The gas traps 14 may divide the plastic in the resulting article. The division of plastic is one result of the injection molding and related components having exceeded the mechanical limitations.

### Article

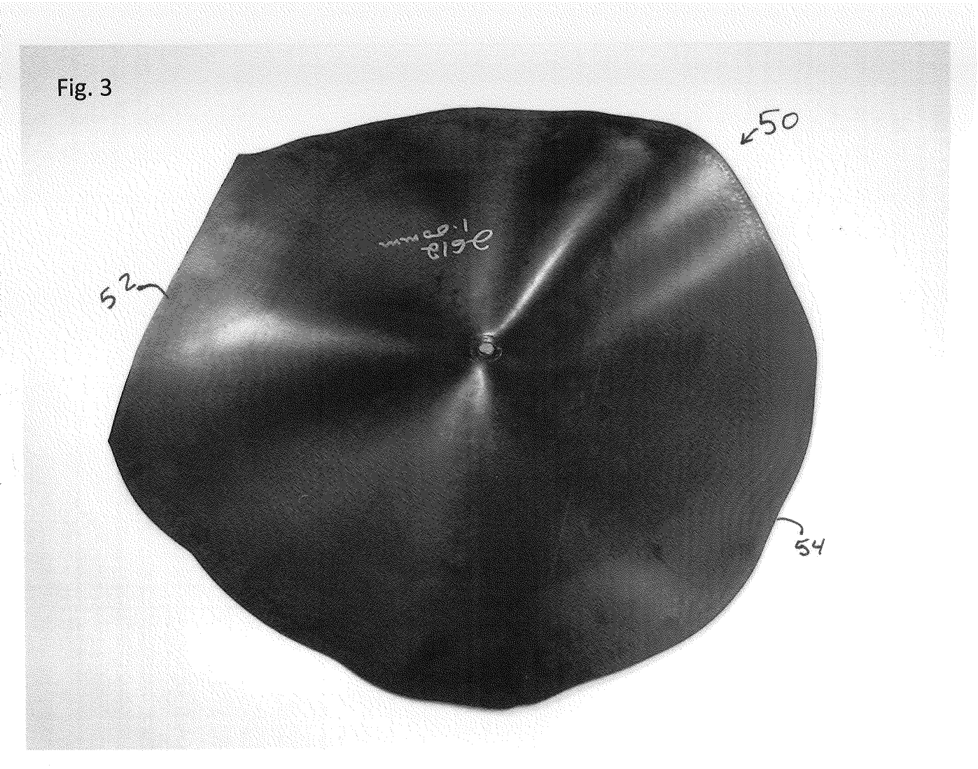

Articles such as mats may provide several uses such as but not limited to, vehicle dash, door, floor panels, interior or exterior trim, or wheel base material. It may be desirable for these mats to have to have small thickness. The mat 50 shown in FIG. 3 was produced with a molding having a nominal interior thickness of 1.0 mm. The mat 50 was produced in a square molding (not shown). One edge 52 of the mat 50 is substantially more linear than the remainder of the periphery 54 indicating that the melted material did not completely fill the molding prior to freezing.

By varying the internal thickness within a molding, there can be provided substantially flat articles, such as mat, that are formed by more complete filling of the molding prior to the setting or freezing of the material. Referring now to FIGS. 4-5, by varying the internal thickness of the molding, a mat generally designated 100 can be provided. The mat 100 has varied thicknesses 120, 140, 160, 180. The largest thickness 120 is about 2.0 mm and the smallest thickness 180 is about 0.25 mm. Combined, the varied thicknesses 120, 140, 160, 180 provide an average thickness 101 over the area of the mat of about 1.125 mm. While the mat 100 has a varied thickness, it is substantially flat over a relatively larger area defined by its length 220 and width 240. In FIG. 5, the transitions 260 between the various thicknesses 120, 140, 160, 180 are roughly shown as corners. However, the transition between thicknesses may be more gradual as indicated by the line 280 in FIG. 5.

The mat 100 may be formed by injection molding from a variety of materials such as, but not limited to, thermoplastics, thermosetting resins and elastomers. More specific examples of the types of materials that may be used to form the mat 100 include, but are not limited to, polyolefin, polyethylene, or polystyrene polymers. Other materials that can generally provide a sheet of lightweight firm and flexible foam are suitable as well.

### Molding

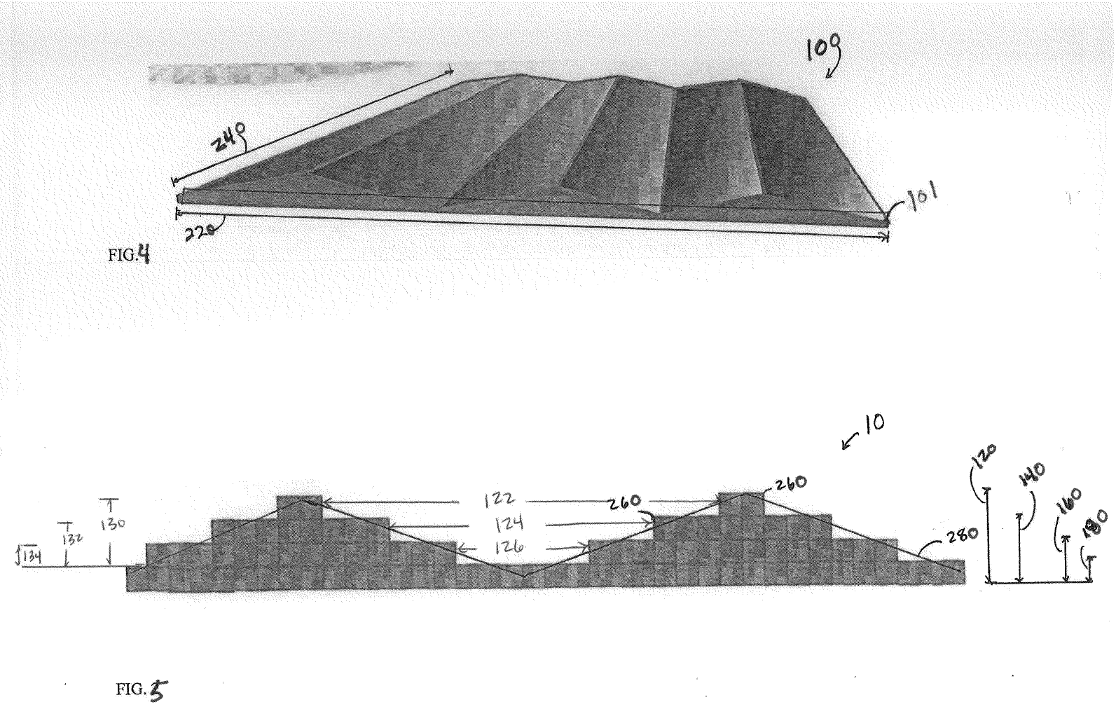

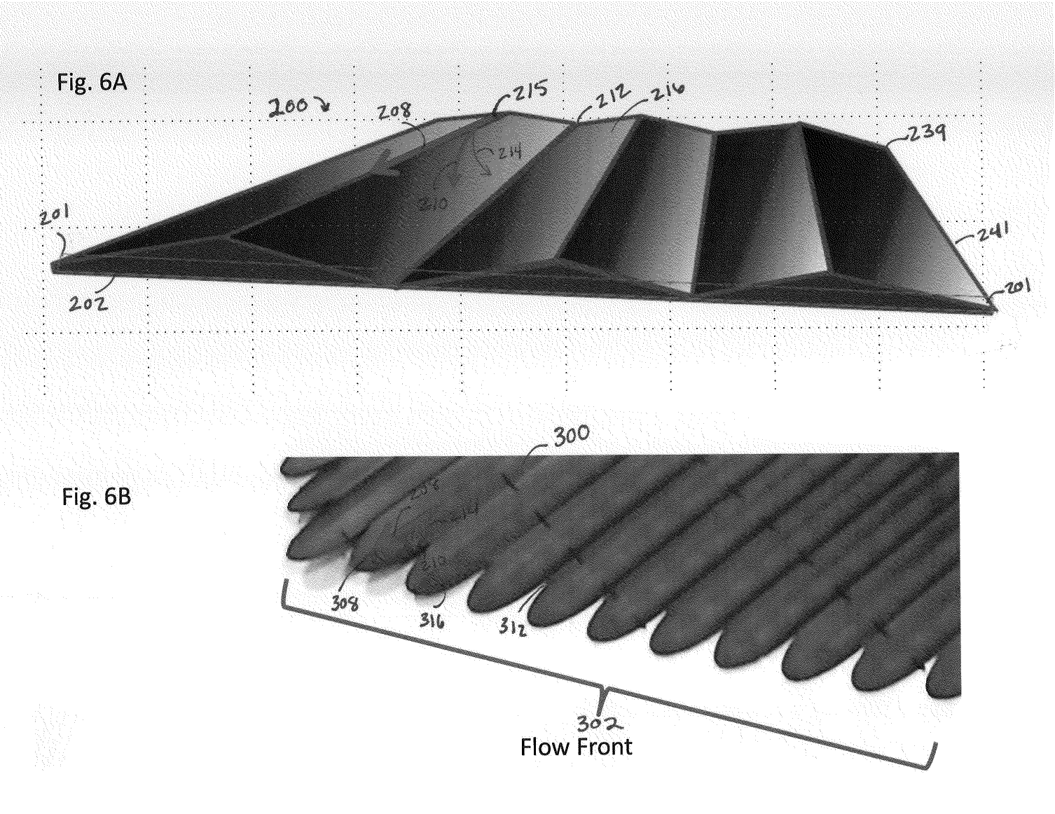

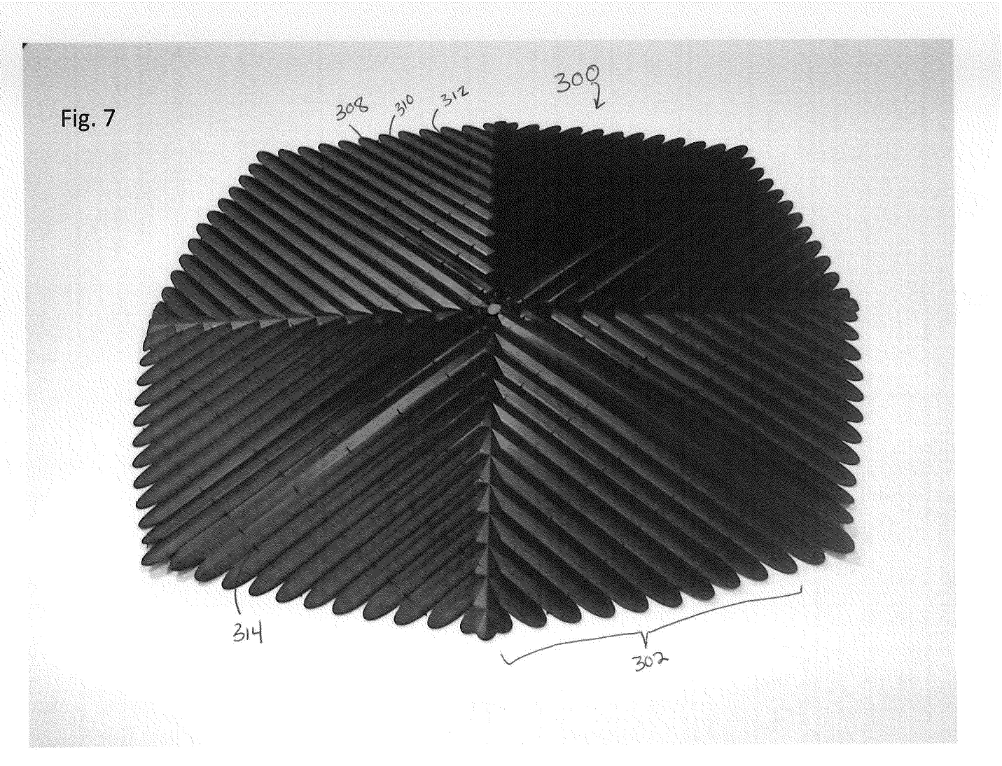

Equipment for producing an article such as the mat 100 includes an injection molding 200 with a base portion forming surface 202 and an opposing portion forming surface 204 as shown in FIG. 6A. The base portion forming surface 202 and opposing portion forming surface 204 having an internal patterned surface (discussed further herein with respect to at least FIGS. 7-8) may be fitted together to form lower and upper internal surfaces in the molding 200. The base portion forming surface 202 and opposing upper portion forming surface 204 of the molding can produce a substantially flat article formed with better, more complete filling of the molding 200 with the melted material. The more complete filling of the molding 200 may be accomplished by the flow pattern of the melted material once introduced into the molding 200. Once the melted plastic is introduced into the molding 200, the material may fill channels in the molding. The channels may be of various sizes depending upon the level of flow of material intended in the corresponding portion of the article. For example, a high-flow channel 208 may receive the melted plastic within the molding 200. The high-flow channel 208 may be a portion of the molding 200 having the thickest interior cross-section. Interior molding cross-sections of smaller area 212 may be filled by smaller flow paths 214 of melted material that branch off from the high-flow channel 208. There may also be one or more intermediately sized cross-sectional areas 216 of the molding 200 through which an intermediate flow path 210 may follow between the high-flow channel 208 and the smaller flow path 214. The molding 200 may taper into corners 239 and a periphery 241 defined by the smaller flow paths 214.

As shown in FIG. 6B, a mat 300 produced from the molding 200 of FIG. 6A may have a flow front 302 created during production. The flow front 302 may be formed by the melted material advancing fastest from its point of introduction 215 through the high-flow channel 208 and trailing in the direction of the material in the high-flow channel 208 may be the material flowing in the intermediate 21 and smaller 214 flow paths. The high-flow channel 208, intermediate 210 and smaller 214 flow paths may correspond to thickest 308, intermediate 316 and smaller 312 thicknesses of the resulting mat 300. Optionally, reinforcing ribs 314 may be included in the molding 200 and incorporated into the mat 300, if desired. As shown in FIG. 7, a mat 300 produced with the molding 200 having a patterned thickness in the opposing portion forming surface 204 toward the base portion forming surface 202 may be provided that is more complete as compared to the mat 50 of FIG. 3 having a consistent nominal thickness.

Referring now to FIG. 8, the molding 400 includes a sprue orifice 401 in communication with a flow leader channel, runner, or high-flow channel 408. In addition to the high-flow channel 408, one or several ancillary, subordinate, distributive or intermediate channels 410 may be included in the molding 400. Ribs 418 may also be provided in the molding 400. For example, the high-flow 408 is adjacent to one or more intermediate channels 410 between the high-flow 408 and a thinnest, shallowest or otherwise smallest or lower-flow channel 412. The high-flow channel 408 can correspond to the thickest cross-section 308 of the mat 300 and has a cross-sectional area defined roughly by a triangle, the area being estimated by one-half the product of its depth 130 and width 122 (as shown in FIG. 5) which is larger than the cross-sectional area of the intermediate thickness 316 of the mat 300 produced in the intermediate channel 410 which has a cross-sectional area that may be estimated by one-half the product of depth 132 and width 124. In turn, the cross-sectional area of the intermediate channel 410 is larger than the cross-sectional area of the smallest mat thickness 312 as may be produced in the smallest channel 412 which has a cross-sectional area that may be estimated by one-half the product of depth 134 and width 126. While FIG. 5 depicts the transitions between the channels to be cornered, the transitions may alternatively be more gradual such as shown by the line 280 or the transitions may be shaped differently depending upon the shape of any shims or other contours as may be included in the molding 400.

The patterned surface 403 of the molding 400 may be arranged to provide a plurality of high-flow channels 408 extending radially from the sprue orifice 401. The pattern shown in FIG. 8 includes six high-flow channels 408 and may be referred to as a “Hex Pattern”. The injection molding that produced the mat 300 of FIG. 7 includes four high-flow channels to produce thickest sections 308 and the mat 300 may be referred to as having a “Quad Pattern”. The moldings 200, 400 may be constructed of steel, aluminum or beryllium-copper alloy.

### Method

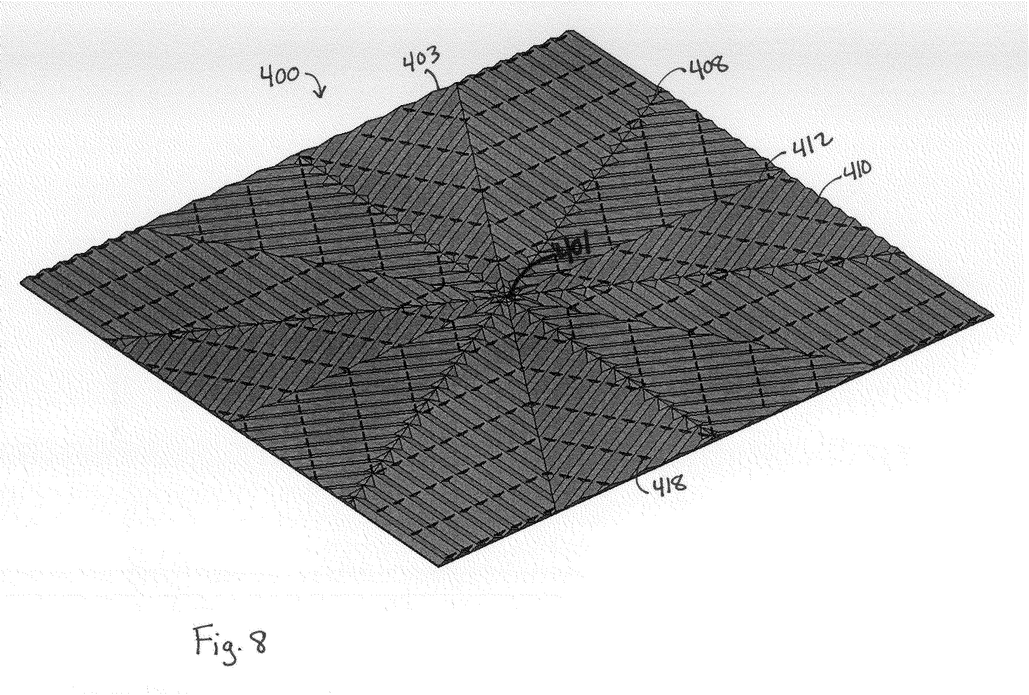

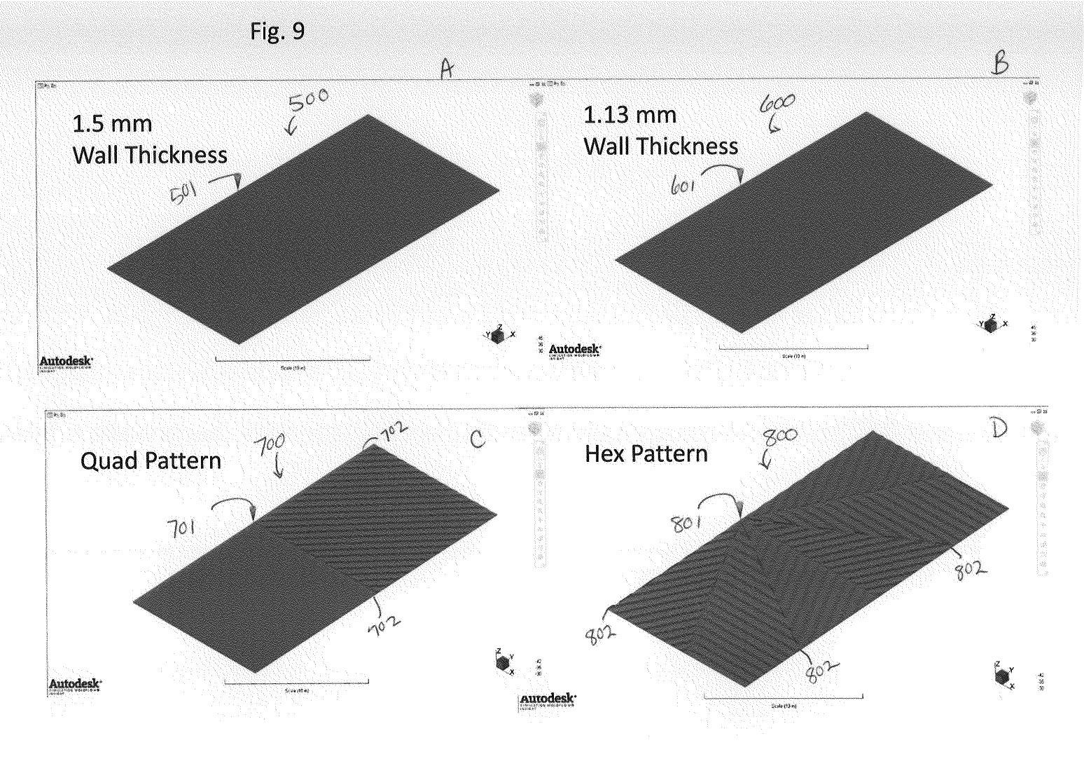

Referring generally to FIGS. 9A-14B, some parameters for the methods used to produce thin articles such as mats may be considered. FIGS. 9A-9D include four examples of plaques that were molded to further demonstrate the features and benefits of the patterned moldings 200 and 400 described herein above. The plaques represent test mats produced in a square molding of roughly 2 feet by 2 feet. Half of such plaques are represented in FIGS. 9A-9D. FIG. 9A represents a plaque 500 produced with a 1.5 mm constant internal thickness molding. The melted material was introduced through sprue orifice 501. FIG. 9B represents a plaque 600 from a molding having a constant internal thickness of about 1.13 mm where the melted material was introduced at sprue orifice 601. FIG. 9C shows a plaque 700 for which a portion represents that this plaque is a Quad Pattern plaque 700 having a total of four high-flow channels 702 and having melted material introduced at spure orifice 701. FIG. 9D represents a Hex Pattern plaque 800 that would include a total of six high-flow channels 802 being filled from sprue orifice 801.

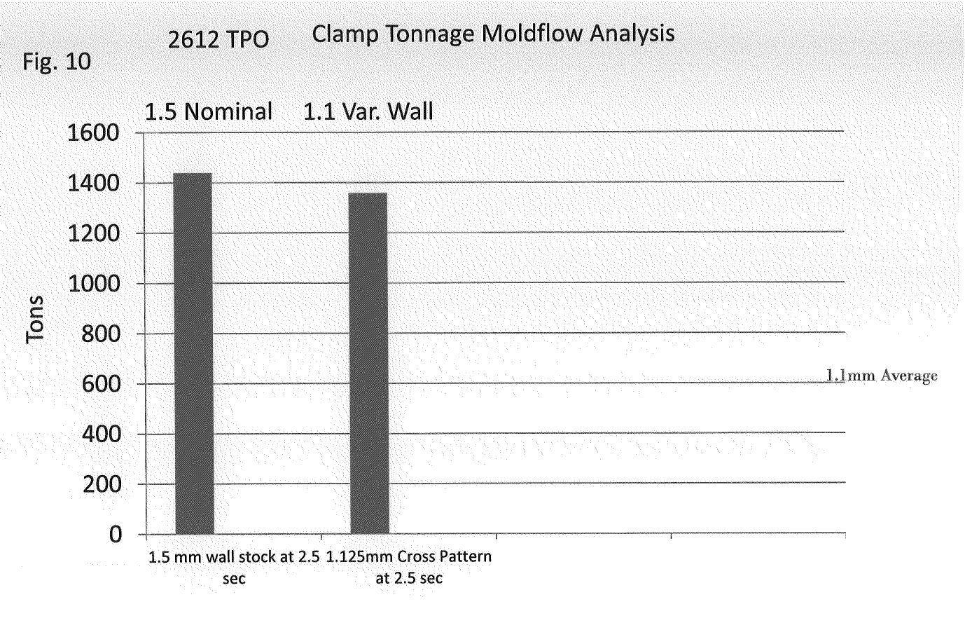

The clamp tonnage required to produce articles may be a factor barring a successful fill of a molding. The clamp tonnage required to produce mats from moldings having a constant thickness and the clamp tonnage required to produce mats having a variable thickness were compared. The clamp tonnage needed to produce a constant thickness mat 500 such as that shown in FIG. 9A required roughly 1420 tons while the clamp tonnage required to produce a Quad Pattern mat 700 such as that shown in FIG. 9C was roughly 1380 tons indicating that there is less force required to clamp the molding together when using a patterned molding. FIG. 10 is a bar graph of the Clamp Tonnage predicted by Moldflow Analysis depicting the results of this comparison.

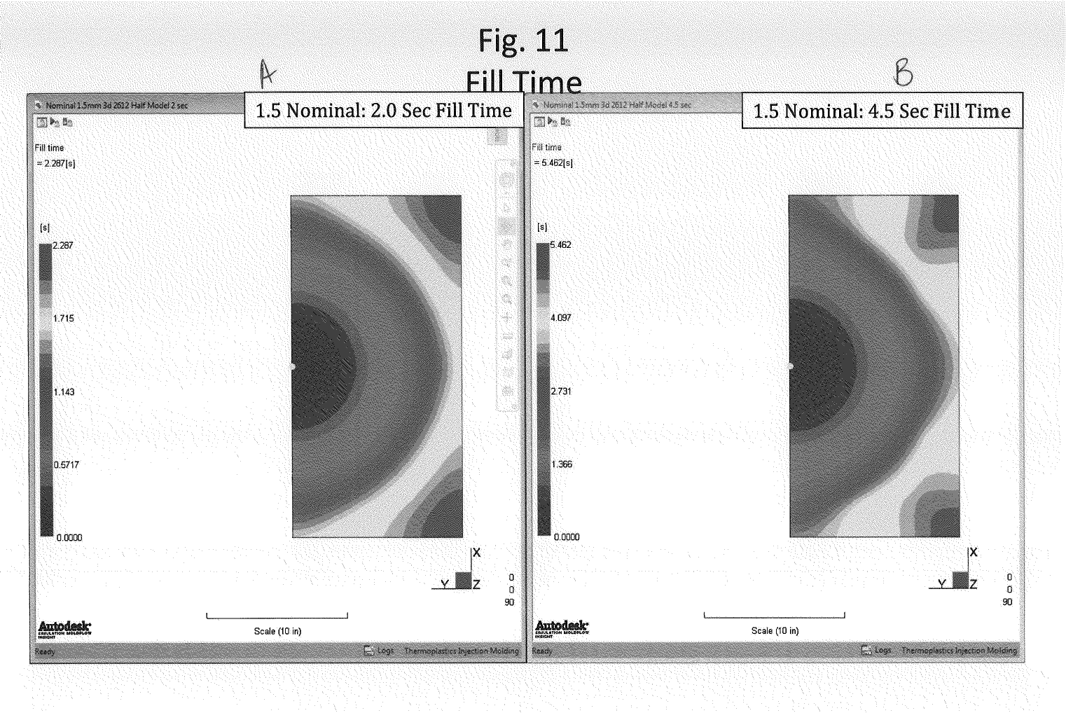

As discussed herein with reference to FIG. 1, the completeness of fill of a molding is typically dependent upon fill time and molding thickness. FIGS. 11A-B and 12A-B depict the extent to which moldings having a constant nominal thickness were filled at with 2.0 seconds of fill time and 4.5 seconds of fill time were examined. FIG. 11A shows the fill pattern of a plaque having a nominal thickness of 1.5 mm when the melted material is pushed into the molding over 2.0 seconds. FIG. 11B shows the fill pattern for the 1.5 mm molding when the material is added more slowly, i.e. over 4.5 seconds. FIGS. 11A and 11B indicate that the moldings were filled by 2.287 seconds and 5.462 seconds, respectively.

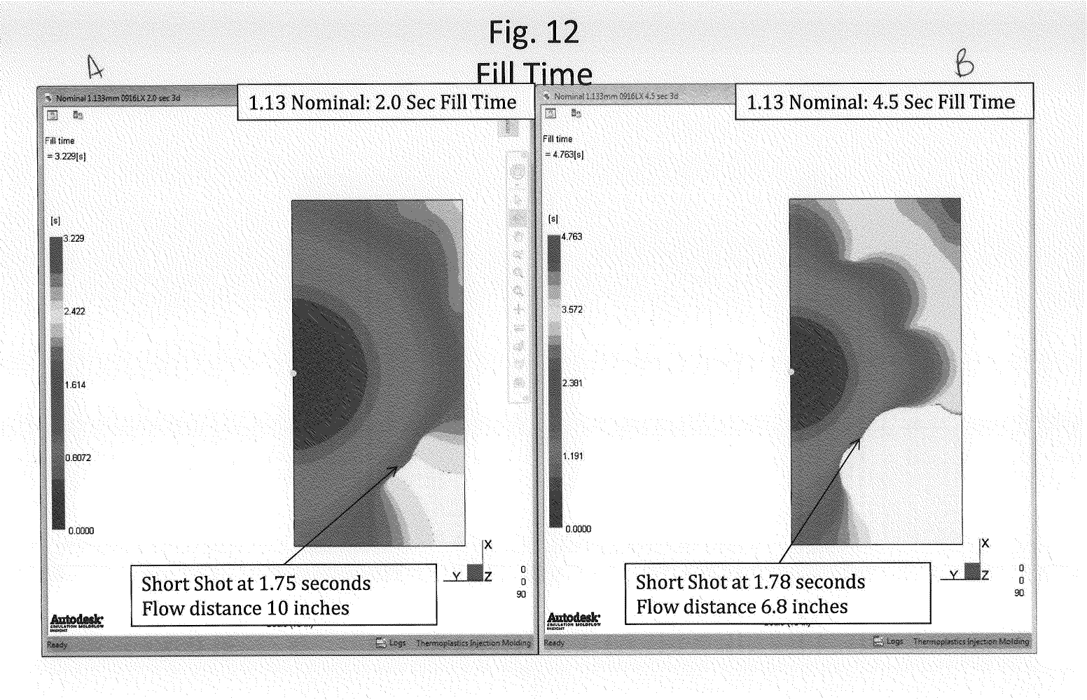

FIG. 12A shows a fill pattern for a plaque having a nominal thickness of 1.13 mm when the melted material is pushed into the molding over 2.0 seconds. FIG. 12B shows the fill pattern for the 1.13 mm molding when the material is added over 4.5 seconds. Both fill patterns for the 1.13 mm plaque indicate that the material will not completely fill the 1.13 mm molding under these conditions resulting in a short shot where a portion of the corners 239 and/or periphery 241 of the molding was not filled. The fill patterns of both FIGS. 12A and 12B indicate that unfilled areas of the molding remained upon freezing of the material at about 3.229 seconds and 4.763 seconds, respectively.

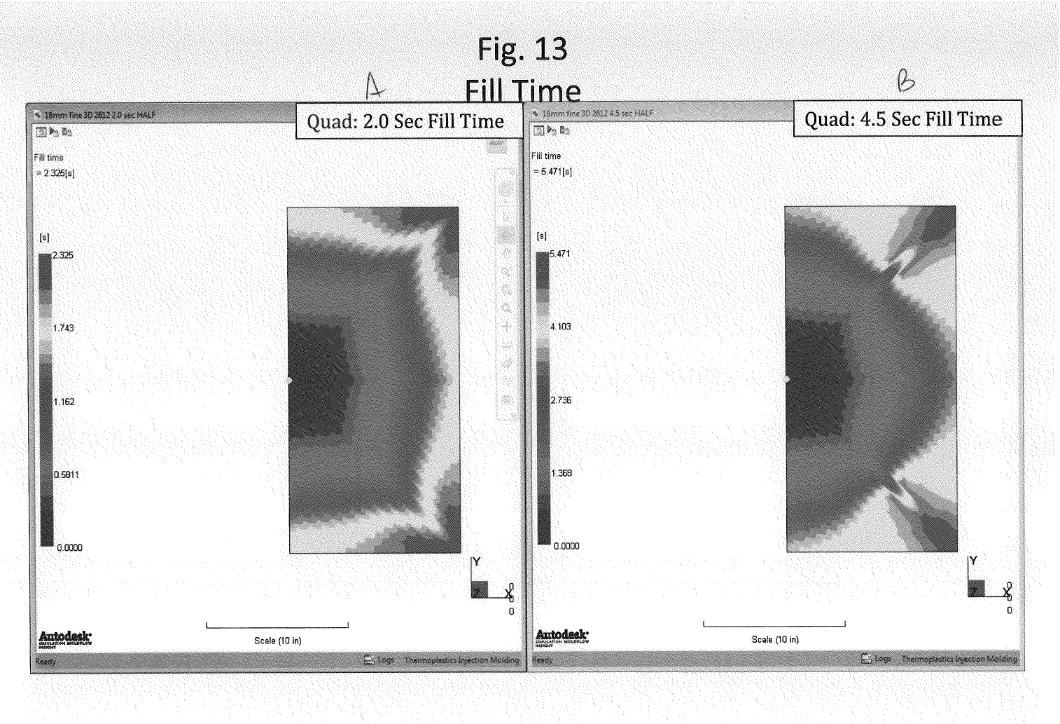

Quad Pattern fill profiles are shown in FIGS. 13A and 13B. Moldings with a Quad Pattern as shown in FIGS. 7 and 9C were filled over a 2.0 second period and a 4.5 second period. As compared to the fill patterns of the 1.5 mm nominal thickness flow pattern of FIGS. 11A-B, the fill pattern for the Quad Pattern molding is more uniform and approaches the extreme corners of the molding earlier than occurs in the constant thickness flow pattern.

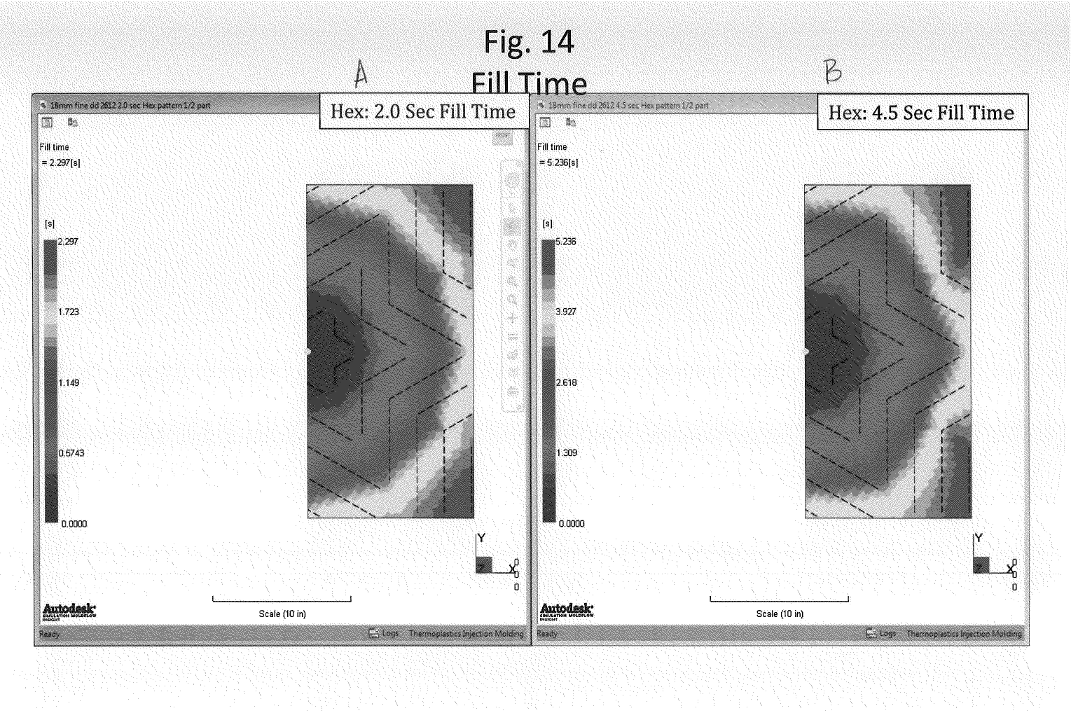

Hex Pattern fill profiles are shown in FIGS. 14 A and 14B. Moldings with a Hex Pattern as shown in FIGS. 8 and 9D were filled over a 2.0 second and 4.5 second period. Similar to the fill profiles shown in FIGS. 13A-B, use of the Hex Pattern molding shows a more uniform fill and faster approach to the extreme corners of the molding as compared to profiles of constant nominal thickness moldings. The Hex Pattern produces a stable filling pattern that maintains shape at different filling speeds.

The Quad Pattern molding produced a mat having an average thickness of about 1.128 mm while the Hex Pattern moldings produced a mat having an average thickness of about 1.133 mm. Both the Quad and Hex Patterned moldings allow for gas to escape as can be seen by the lack of gas traps in the fill patterns. These patterned moldings allow for the production of a more evenly textured article with a reduced average thickness as compared to the nominal thickness moldings.

Typically, the pressure required to hold the molding together (clamp tonnage) during the fill time increases as the fill time increases. This relationship is demonstrated by the data in Table 1, below, with respect to the clamp tonnage increase shown to fill the 1.5 mm molding over 4.5 seconds as compared to 2.0 seconds. However, during use of the Hex Pattern molding, the clamp tonnage decreased when the fill time was longer, yielding a surprising and unexpected result. By using intersecting flow channels, such as high-flow channel 408, intermediate 410 and smaller 412 channels, the flow front is not required to pass through a region of the molding having only the smaller channels 412 so that excessive pressure is not accumulated. The use of parallel and intersecting flow channels allows for lower pressure requirements and lower material usage.

TABLE 1
Summary of Pressure and Clamp Tonnage

| | | | Clamp |
|---|---|---|---|
| | Equivalent | Injection | Tonnage @ |
| | thickness | Pressure | switchover |
| 2x2′ Plague | (mm) | (psi) | (ton) |
| Nominal 1.5 mm 3 d 2612 2.0 sec | 1.5 | 10,110 | 1,230 |
| Nominal 1.5 mm 3 d 2612 4.5 sec | 1.5 | 14,120 | 1,800 |
| Nominal 1.133 2612 2.0 sec | 1.133 | Short shot | |
| Nominal 1.133 2612 4.5 sec | 1.133 | Short shot | |
| Quad 2612 2.0 sec | 1.128 | 11,090 | 1,380 |
| Quad 2612 4.5 sec | 1.128 | 14,770 | 2,030 |
| Hex 2612 2.0 sec | 1.133 | 10,690 | 1,290 |
| Hex 2612 4.5 sec | 1.133 | 10,125 | 1,070 |

Methods for making the mat may include the steps of providing an injection molding with a patterned surface such as, but not limited to, the Quad Pattern or Hex Pattern described above. Then introducing over a period of time a flow of molten material through an opening such as a sprue orifice and into a flow leader or high-flow channel. The molten material introduced into the high-flow channel may be distributed to ancillary channels that are lower-flow and/or intermediate flow channels to produce lower-flow and/or intermediate flow paths. The flow front advances along the high-flow channels and lower-flow, intermediate flow channels and/or the ancillary channels. The method includes applying a clamping pressure to the injection molding.

The method can include providing within the molding a reinforcing material. And may also provide for the curing or setting of the molten material after the corner and/or peripheral edge is filled with the molten material. In addition to providing the patterned molding, the steps of creating a flow front and applying clamping pressure advance the flow of molten material substantially to the corners and peripheral edges prior to the step of allowing the molten material to cure.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A method for manufacturing a variable thickness article, comprising:
providing an injection molding, the injection molding comprising:
a high-flow channel in communication with a sprue orifice, said high-flow channel having a cross-sectional area within said injection molding;
a lower-flow channel adjacent said high-flow channel, said lower-flow channel having a smaller cross-sectional area than the cross-sectional area of the high-flow channel within said injection molding;
providing a flow of molten material through said sprue orifice and into said high-flow channel; and
creating a flow front of said molten material within said injection molding, said flow front advancing along said high-flow channel and into said lower-flow channel,
wherein said flow of molten material is directed into said lower-flow channel from said high-flow channel at or near said flow front.

2. The method of claim 1 wherein the step of providing an injection molding comprises an injection molding having an area and a thickness where said molding area is substantially larger than said molding thickness.

3. The method of claim 1 wherein said injection molding comprises a molding periphery and wherein the steps of creating a simultaneously advancing flow front and applying a clamp pressure further advance said molten material to said molding periphery.

4. The method of claim 1 wherein said injection molding further comprises at least one intermediate-flow channel between said high-flow channel and said lower-flow channel, a cross-sectional area of said intermediate-flow channel being smaller than said high-flow channel cross-sectional area and larger than said lower-flow channel cross-sectional area.

5. The method of claim 1 wherein the injection molding includes between 4 and 6 high-flow channels.

6. The method of claim 1 wherein said high-flow channel has a thickness of about 2 mm and said lower-flow channel has a thickness about 0.25 mm.

7. A mat produced by the method of claim 1 comprising a cross-section of variable thickness of about 2 mm to about 0.25 mm.

8. A mat produced by the method of claim 1 having an average thickness of between about 1.128 mm and 1.133 mm.

9. A mat produced by the method of claim 1 wherein the material is selected from a group consisting of thermoplastics, thermosetting resins, and elastomers.

10. The mat of claim 9 wherein the material is selected from a group consisting of polyolefin, polyethylene, and polystyrene polymers.

11. An injection molding for molding an article having a patterned thickness comprising:
a plurality of high-flow channels;
a plurality of lower-flow channels intersecting said high-flow channels; and
a sprue orifice in communication with said high-flow channels,
wherein said lower-flow channels have a smaller cross-sectional area within the injection molding than a cross-sectional area of said high-flow channels,
wherein the injection molding has a width and a length both larger than a thickness of the molding.

12. The injection molding of claim 11 wherein the molding further comprises 4 high-flow channels.

13. The injection molding of claim 11 wherein the molding further comprises 6 high-flow channels.

14. The injection molding of claim 11 wherein said high-flow channels extend radially from said sprue orifice.

15. The injection molding of claim 11 wherein the pattern thickness spans an entire internal molding area.

16. The injection molding of claim 11 wherein the molding is constructed of steel, aluminum, or beryllium-copper alloy.

17. A method for manufacturing a mat, comprising:
providing an injection molding having a patterned internal thickness, the injection molding comprising:
a sprue orifice in communication with a plurality of high-flow channels; and
a plurality of lower-flow channels in communication with said high-flow channels,
wherein said lower-flow channels have a smaller cross-sectional area within the injection molding than a cross-sectional area of said high-flow channels,
wherein the injection molding has a width and a length both larger than a thickness of the molding.
providing a flow of molten material through said sprue and into said high-flow channels;
creating a flow front with said injection molding, said flow front advancing from said sprue along said high-flow channels and said lower-flow channels; and
applying a clamping pressure to said injection molding.

18. The method of claim 17 wherein the molding has an average internal thickness of between about 1.128 mm and about 1.133 mm.

19. The method of claim 17 wherein the molding has 4 high-flow channels.

20. The method of claim 17 wherein the molding has 6 high-flow channels.
